(19) United States
(12) Patent Application Publication
(10) Pub. No.: US 2009/0151174 A1
(43) Pub. Date: Jun. 18, 2009

(54) Motor-driven reciprocating saw

(75) Inventors: Adrian Steingruber, Schwabmuenchen (DE); Frank Despineux, Friedrichshafen (DE); Guenter Haas, Kaufering (DE)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 12/316,544

(22) Filed: Dec. 11, 2008

(30) Foreign Application Priority Data
Dec. 12, 2007 (DE) 10 2007 055 781.9

(51) Int. Cl. B27B 19/09; B25F 5/00

(52) U.S. Cl. 30/394; 30/289

(57) ABSTRACT

A motor-driven reciprocating saw (10) includes a guide device (20) the guide member (21) of which has a base body (25) and a guide sole (27) provided on the base body (25) and having a first layer (31) formed of a rigid material with a low frictional adhesion and forming a bearing surface (28) for the workpiece, a third layer (33) likewise formed of a rigid material and formed integrally with the base body (25), and a second layer (32) formed of a vibration-damping material and located between the first and third layers (31 and 33).

### BACKGROUND OF THE INVENTION

1. Field of the Invention

The present invention relates to a motor-driven reciprocating saw including a guide device having a guide member for guiding the saw over a workpiece and having a base body and a guide sole provided on the base body and including a bearing surface.

2. Description of the Prior Art

Known reciprocating saws such as, e.g., saber saws, have guide means such as guide shoe for a reliable, precise guidance of a reciprocating saw over a workpiece. The guide means is pressed against the workpiece during work with a reciprocating saw.

U.S. Pat. No. 5,421,091 discloses a motor-driven reciprocating saw which is formed as a saber saw and has a housing, a guide shoe for guiding the saber saw over a workpiece, and a motor-driven, in pendulum-like manner, push rod. The guide shoe is pivotally supported in a longitudinal opening at an end of a connection rail, with the connection rail being guided in a house opening and being formlockingly secured therein.

The drawback of the above-described saber saw consists in that the vibrations, which act on the guide shoe during operation of the saber saw, are transmitted to the housing neck which functions as a hand-hold.

Japanese Publication JP 4 053 620 discloses a motor-driven reciprocating saw which is formed as a hack saw and a guide shoe of which used for guiding the reciprocating saw over a workpiece, has, on its side adjacent to the workpiece, an elastic layer.

The drawback of the reciprocating saw, which is disclosed in the above-discussed Japanese Publication, consists in that the elastic layer, because of an increased frictional adhesion to the workpiece, brakes the displacement of the saw. On the other hand, the elastic layer is subjected to an increased wear. In addition, chips, in particular of heated metals, can remain on this layer which can lead to scratches of a sensitive outer surface of a subsequently treated workpiece surfaces.

Accordingly, an object of the present invention is a reciprocating saw having a guide member in which the foregoing drawbacks are prevented and the vibrations of which are reduced.

### SUMMARY OF THE INVENTION

This and other objects of the present invention, which will become apparent hereinafter, are achieved by providing a guide member (guide shoe) the guide sole of which has a first layer formed of a rigid material with a low frictional adhesion and forming a bearing surface for the workpiece, a third layer likewise formed of a rigid material and formed integrally with the base body of the guide shoe, and a second layer formed of a vibration-damping material and located between the first and third layers.

With a second, intermediate layer, a good damping of vibrations between the bearing surface of the guide member and the main portion of the reciprocating saw, which includes the saw housing and the handle, or the handle means is achieved. On the other hand, the reciprocating saw is easily guided over the workpiece, without the displacement of the bearing surface being braked. The danger of scratches of the surfaces of the sawed workpieces by the chips clinging to the guide means is likewise prevented to a great extent. The chips can be easily wiped of the bearing surface.

Advantageously, the second layer is formed of a foam material, which insures an optimal vibration damping.

Alternatively, the second layer can be formed of an elastomeric material. This likewise insures an optimal damping.

Advantageously, the first and third layers are formed of metal. This insures an easy manufacturing of the guide sole, on one hand, and on the other hand, makes the guide shoe stable.

Advantageously, the first layer is formed of an aluminum, which makes the guide shoe relatively light, and the bearing surface is not subjected or almost not subjected to corrosion. Further, because aluminum is a soft metal, the scratching of the surfaces by the bearing surface is prevented.

Advantageously, the third layer is formed of steel. This insures a high stability of the guide shoe. Besides, the steel of the third layer can be easily connected, e.g., by welding with other steel parts.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a side view of a saber saw according to the present invention; and

FIG. 2 a longitudinal, partially cross-sectional view of a detail of the saber saw shown in FIG. 1 and including the guide shoe.

### DETAILED DESCRIPTION OF THE PREFERRED EMBODIMENT

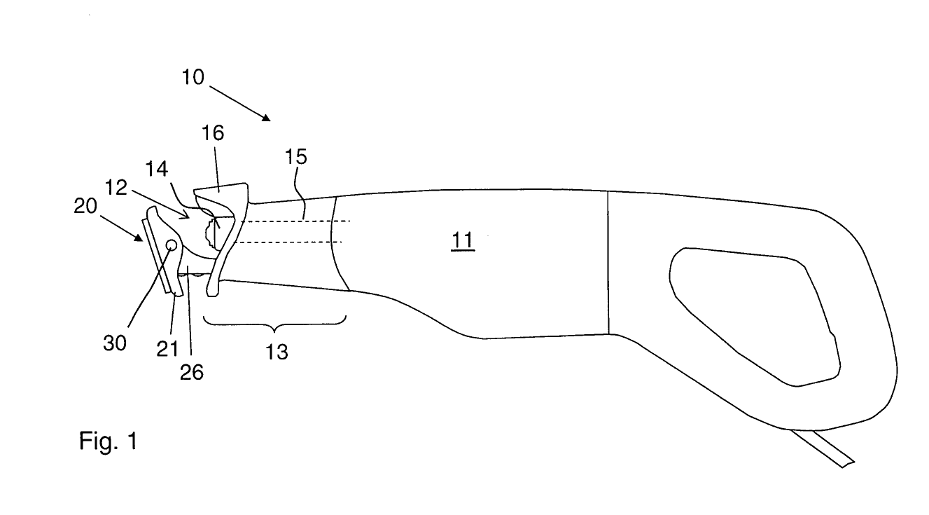

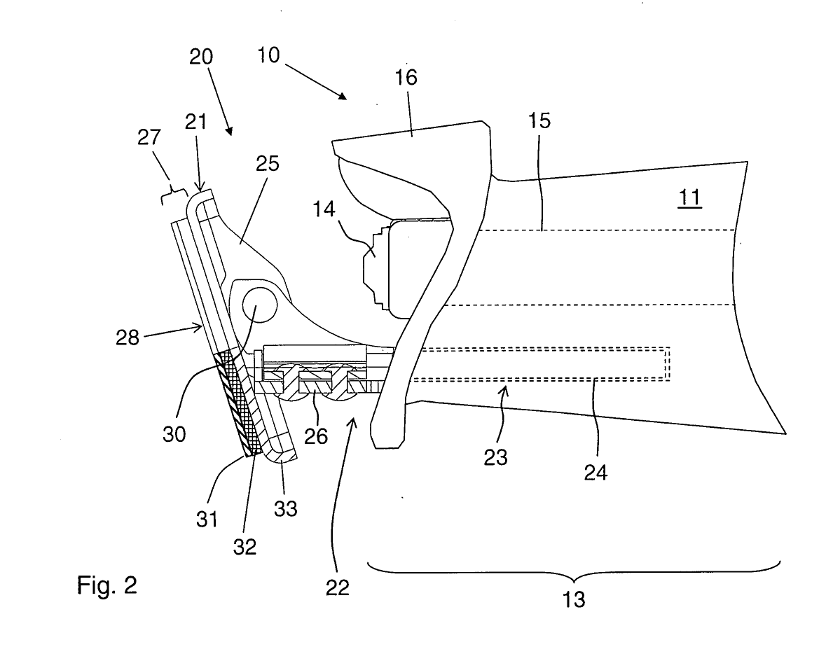

A motor-driven reciprocating saw 10 according to the present invention, which is formed as a saber saw and is shown in FIGS. 1-2, includes a housing 11 having, at its working tool end, an opening 12 for a working tool. A portion of the housing 11 with the opening 12 forms the saw neck 13 that is used as a hand-hold. For this reason, in an assembled condition, the saw includes a hand protector 16 that surrounds the neck 13.

A tool holder 14, which is mounted on a push rod 15, shown with dash lines, together with a saw blade (not shown) which is secured thereon, reciprocates through the working tool opening 12.

The reciprocating saw 10 has a guide device 20 with a guide member 21 in form of a guide shoe. The guide member 21 is secured on the housing 11 with a connection device 22 that can be inserted, in the longitudinal direction of the neck 13, in a receptacle 23 (shown in FIG. 2 with dash lines) of the housing 11 for the connection device 22.

The connection device 22 has two rod-shaped connection member 24 (shown schematically in FIG. 2) having a circular cross-section. The connection members 24 has each a locking element which cooperates, in an assembled condition of a respective connection member 24 on the housing neck 13, with a counter-element for fixedly securing the respective connection member 24 on the housing neck 13 (locking and counter-locking elements are not shown in the drawings). At their ends remote from the neck 13, the connection members 24 are connected with a support member 26 on which a base body 25 of the guide member 21 is pivotally supported by a support pin 30.

A guide member 21, which is formed as a guide shoe, has a multi-layer guide sole 27. The guide sole 27 has a first layer 31 which forms a bearing surface 28 for a workpiece and which is formed of a rigid material having a low frictional adhesion, such as, e.g., aluminum, steel, or any other suitable metal or a fibrous composite. Adjacent to the first layer, there is provided a second layer 32 of a vibration-damping material that damps vibrations during the operation of the reciprocating saw 10. As a vibration-damping material, e.g., a foam material or an elastomeric material can be used. The first layer 31 and the second layer 32 can, e.g., be glued with each other. The second layer 32 of a vibration-damping material lies on a third layer 33 that again is formed of a rigid material such as metal (e.g., steel) or fibrous composite. The third layer 33 is formed integrally with the base body 25 of the guide member 21. The second layer 32 of a vibration-damping material can be glued with the third layer or vulcanized thereon.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A motor-driven reciprocating saw (10), comprising a guide device (20) having a guide member (21) for guiding the saw (10) over a workpiece, the guide member (21) having a base body (25) and a guide sole (27) provided on the base body (25) and including a first layer (31) formed of a rigid material with a low frictional adhesion and forming a bearing surface (28) for the workpiece, a third layer (33) likewise formed of a rigid material and formed integrally with the base body (25), and a second layer (32) formed of a vibration-damping material and located between the first and third layers (31 and 33).

2. A reciprocating saw according to claim 1, wherein the second layer (32) is formed of a foam material.

3. A reciprocating saw according to claim 1, wherein the second layer is formed of an elastomeric material.

4. A reciprocating saw according to claim 1, wherein the first and third layers (31 and 33) are formed of metal.

5. A reciprocating saw according to claim 1, wherein the first layer (31) is formed of aluminum.

6. A reciprocating saw according to claim 1, wherein the third layer is formed of steel.
